(19) United States
(12) Patent Application Publication
(10) Pub. No.: US 2026/0361247 A1
(43) Pub. Date: Nov. 12, 2026

(54) ROTOR POSITION ESTIMATION TECHNIQUES FOR SYNCHRONOUS MACHINES

(71) Applicant: Caterpillar Inc., Peoria, IL (US)

(72) Inventors: Jingjie Wu, Madison, WI (US); Ahmed Khalil, Dunlap, IL (US); Lei Zhou, Middleton, WI (US); Jackson Wai, Dunlap, IL (US); Jiayuan Zhang, Dunlap, IL (US); Bishwajyoti Purkayastha, Kolkata (IN); Laura A. Homiller, Madison, WI (US)

(21) Appl. No.: 19/203,888

(22) Filed: May 9, 2025

(51) Int. Cl. H02P 21/18; H02P 21/09; H02P 21/13; H02P 21/20

(52) U.S. Cl. CPC H02P 21/18; H02P 21/09; H02P 21/13; H02P 21/20; H02P 2207/05

(57) ABSTRACT

A tracking differentiator (TD) is used to process the estimated rotor speed and generate a smooth and accurate estimate of rotor acceleration. The tracking differentiator ensures noise suppression and provides reliable acceleration data, even under dynamic conditions. The estimated rotor acceleration is then used to dynamically schedule the proportional and integral gain parameters of the PLL. During transient conditions, such as rapid acceleration or deceleration, the gain parameters are increased, such as to improve responsiveness and reduce position estimation errors. Under steady-state conditions, the gain parameters revert to their nominal values, such as to maintain stability and minimize noise.

### FIELD OF THE DISCLOSURE

This document pertains generally, but not by way of limitation, to motor control systems, and more specifically to sensorless control techniques for interior permanent magnet machines.

### BACKGROUND

Interior permanent magnet (IPM) motors are a type of synchronous machine in which permanent magnets are embedded within the rotor core rather than mounted on the surface. This rotor configuration provides both high torque density and improved field-weakening capability, making IPM motors well-suited for applications that require wide speed ranges and high efficiency, such as electric vehicles.

Sensorless control techniques eliminate the need for physical position sensors, such as encoders, which may add cost, size, and reliability concerns to the system. Instead, sensorless control algorithms estimate the rotor position and speed in real-time based on electrical measurements, such as stator voltages and currents. This approach reduces system complexity, improves mechanical robustness, and is particularly desirable in environments where sensors are impractical due to space constraints, harsh operating conditions, or cost limitations. Sensorless control is especially beneficial in IPM motors, where the rotor's magnetic characteristics enable position estimation at low speeds using signal injection methods and at higher speeds through back-EMF-based observers.

CN119030401A relates to a permanent magnet synchronous motor sensorless control method based on a phase feed-forward phase-locked loop, which adopts a PI regulator double-closed-loop vector control mode of a rotating speed outer loop and a current inner loop.

### SUMMARY OF THE DISCLOSURE

This disclosure describes, among other things, the use of a tracking differentiator (TD) to process the estimated rotor speed and generate a smooth and accurate estimate of rotor acceleration. The tracking differentiator ensures noise suppression and provides reliable acceleration data, even under dynamic conditions. The estimated rotor acceleration is then used to dynamically schedule the proportional and integral gain parameters of the PLL. During transient conditions, such as rapid acceleration or deceleration, the gain parameters are increased, such as to improve responsiveness and reduce position estimation errors. Under steady-state conditions, the gain parameters revert to their nominal values, such as to maintain stability and minimize noise.

In some aspects, this disclosure is directed to a method for improving an accuracy of rotor position estimation of a rotor in a permanent magnet machine, the method comprising: estimating a rotor speed from electrical signals indicative of machine operation; applying a tracking differentiator to the estimated rotor speed to determine an estimated rotor acceleration; adapting proportional and integral gain parameters of a phase-locked loop (PLL) based on the estimated rotor acceleration; using the adapted gain parameters to generate an estimated angular position output of the rotor; and controlling the machine based on the estimated angular position output and the estimated rotor speed to regulate a torque of the machine.

In some aspects, this disclosure is directed to a motor system comprising: a permanent magnet motor including a rotor: a motor controller configured for: receiving an estimated rotor speed signal derived from electrical signals indicative of motor operation; applying the estimated rotor speed to determine an estimated rotor acceleration; adapting proportional and integral gain parameters of a phase-locked loop (PLL) based on the estimated rotor acceleration; using the adapted gain parameters to generate an estimated angular position output of the rotor; and controlling the motor based on the estimated angular position output and the estimated rotor speed to regulate a torque of the motor.

In some aspects, this disclosure is directed to a motor controller for improving an accuracy of a rotor position estimation in an interior permanent magnet motor, the motor controller comprising: a tracking differentiator configured for: receiving an estimated rotor speed signal derived from electrical signals indicative of motor operation and calculate an estimated rotor acceleration signal by determining a first derivative of the estimated rotor speed; and adapting proportional and integral gains of a phase-locked loop (PLL) based on the estimated rotor acceleration signal using a gain scheduling function; a phase-locked loop configured for using the adapted proportional and integral gains to generate an angular position output of a rotor; and a torque control loop configured to incorporate the angular position output to regulate motor operation.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIG. 1 is a perspective view of an example of an electric drive system that may implement various techniques of this disclosure.

FIG. 2 illustrates an aspect of the subject matter in accordance with one embodiment.

FIG. 3 is a block diagram of an example of a sensorless control system for an Interior Permanent Magnet (IPM) motor.

FIG. 4 is a block diagram of an example of an enhanced quadrature phase-locked loop (EQPLL).

FIGS. 5A-5E depict various graphs showing simulation results depicting the open-loop performance of the enhanced quadrature phase-locked loop of FIG. 4.

FIG. 6 illustrates an aspect of the subject matter in accordance with one embodiment.

FIGS. 7A-7E depict various graphs showing simulation results depicting the closed-loop performance of the variable phase-locked loop of FIG. 6.

FIG. 8 is a block diagram of an example of a closed-loop tracking differentiator-based variable phase-locked loop 800 with speed compensation, in accordance with this disclosure.

FIGS. 9A-9E depict various graphs showing simulation results depicting the closed-loop performance of the tracking differentiator-based variable phase-locked loop 800 with speed compensation of FIG. 8.

FIG. 10 is a block diagram of an example of a feedforward phase-locked loop 1000, in accordance with this disclosure.

FIGS. 11A-11E various graphs showing simulation results depicting the closed-loop performance of the feedforward phase-locked loop 1000 of FIG. 10.

FIG. 12 is a block diagram of an example of a phase-locked loop that includes the closed-loop tracking differentiator-based variable phase-locked loop with speed compensation of FIG. 8 and the feedforward phase-locked loop of FIG. 10, in accordance with this disclosure.

FIG. 13 is a flow diagram of an example of a method for improving an accuracy of rotor position estimation of a rotor in a permanent magnet synchronous machine, in accordance with this disclosure.

### DETAILED DESCRIPTION

In motor control systems, acceleration and deceleration are frequent due to changes in speed reference requirements and the effects of disturbance torque. Speed reference changes occur when the motor needs to adapt to varying operational demands, such as starting, stopping, or transitioning between different speeds. Disturbance torque, caused by external forces like mechanical loads, friction, or gravity, may also lead to unexpected changes in rotor speed.

Under these dynamic operating conditions, maintaining accurate rotor position estimation becomes challenging. Large position estimation errors during acceleration or deceleration may result in degraded efficiency, reduced performance, or even instability in motor operation. The present inventors have recognized that fixed-gain phase-locked loop (PLL) systems are insufficient for handling these conditions effectively, as they cannot adapt their responsiveness to the varying magnitude of acceleration or deceleration. The present inventors have recognized a need for a control system capable of dynamically adjusting its parameters to ensure robust and accurate performance.

This disclosure describes, among other things, the use of a tracking differentiator (TD) to process the estimated rotor speed and generate a smooth and accurate estimate of rotor acceleration. The tracking differentiator ensures noise suppression and provides reliable acceleration data, even under dynamic conditions. The estimated rotor acceleration is then used to dynamically schedule the proportional and integral gain parameters of the PLL. During transient conditions, such as rapid acceleration or deceleration, the gain parameters are increased, such as to improve responsiveness and reduce position estimation errors. Under steady-state conditions, the gain parameters revert to their nominal values, such as to maintain stability and minimize noise.

Additionally, the estimated rotor acceleration is utilized to enhance the outer loop speed control by estimating the disturbance torque. This disturbance torque is applied as a feedforward term, which significantly reduces speed errors during transient responses and improves overall dynamic performance.

Finally, to achieve optimal performance and robustness across both loaded and non-loaded operating conditions, a low-pass filtered (LPF) feedforward PLL is integrated into the system. This addition reduces both steady-state and transient position estimation errors, ensuring precise and reliable motor control under varying operating conditions.

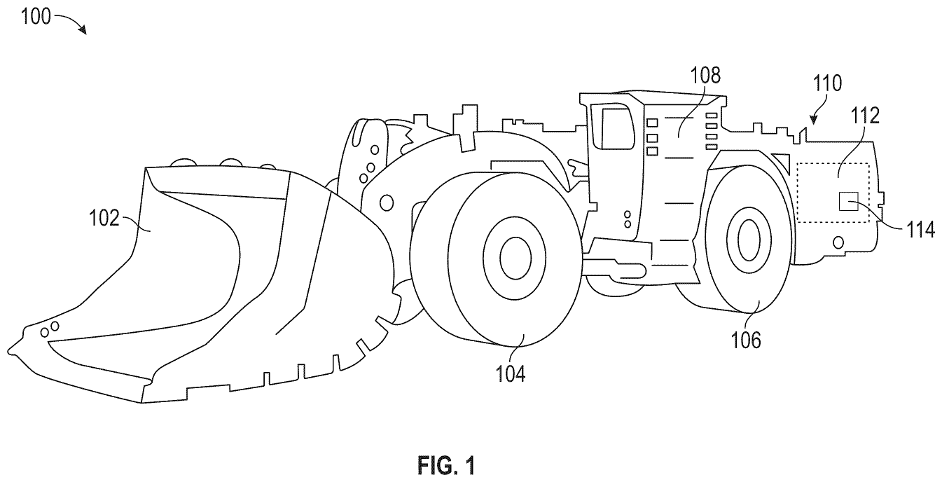

FIG. 1 is a perspective view of an example of an electrified machine 100 that may implement various techniques of this disclosure. FIG. 1 depicts a non-limiting example of an electrified machine 100 in the form of a load-haul-dump (LHD) vehicle including a dump bucket 102, wheels 104, 106, an operator control cabin 108, and a vehicle body 110.

The electric machine 100 also includes an electrical architecture 112. The electrical architecture 112 may include a DC power source, including but not limited to a battery module, that may supply power to, among other things, an electric machine 114, e.g., an electric motor or electric generator. The electrical architecture 112 may supply power to, among other things, the electric motor. The electric machine may supply power to one or more control systems, such as a control system configured to operate various hydraulics of the dump bucket 102. The techniques of this disclosure are not limited to the LHD vehicles and are instead applicable to other industrial vehicles including, but not limited to, continuous miners, feeder breakers, roof bolters, utility vehicles for mining, underground mining loaders, underground articulated trucks, or any other vehicle used for industrial purposes, such as hauling, excavating, drilling, loading, dumping, compacting, etc.

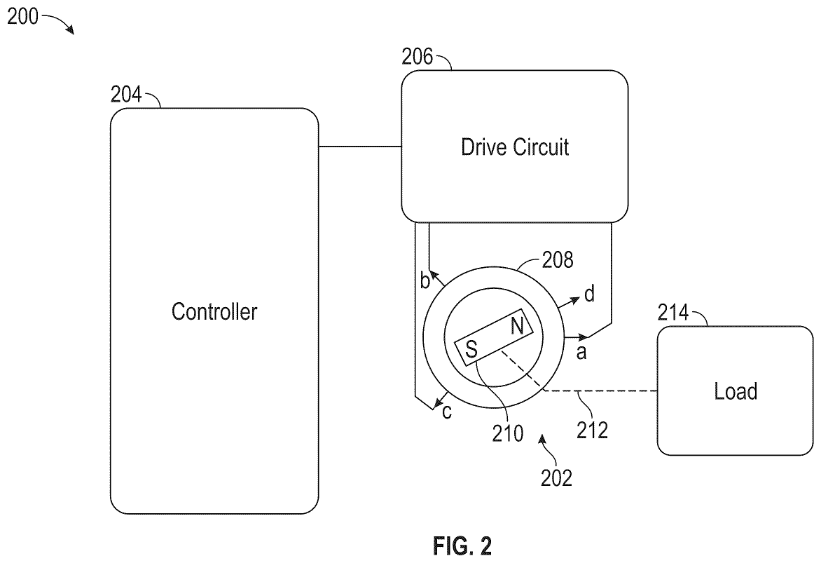

FIG. 2 is a schematic view of an example of an electric drive system 200 that may implement various techniques of this disclosure. The electric drive system 200 may be used to control the electric machine 114 of FIG. 1, such as an interior permanent magnet machine 202 (IPM) or any other suitable and comparable machine, that may be electrically operated to produce rotational torque. The interior permanent magnet machine 202 may be configured to operate as either a motor to convert electrical energy to mechanical energy or a generator that does the reverse.

In the example shown, the electric drive system 200 includes a controller 204, e.g., motor controller, that manages operation of the interior permanent magnet machine 202 through control a drive circuit 206 electrically coupled to a stator 208 of the interior permanent magnet machine 202. The controller 204 includes at least one processor and at least one memory device. The memory device stores computer-readable instructions that implement the techniques of this disclosure and that is executable by the processor(s). Based on the desired application, a rotor 210 rotatably disposed within the stator 208 may be controlled to generate a rotational torque to be communicated through an output shaft 212 to a load 214. The load 214 may include any one or more of a traction device for causing movement of an associated machine, a machine or work tool, and the like. The controller 204 may implement the phase-locked loop techniques of this disclosure described below.

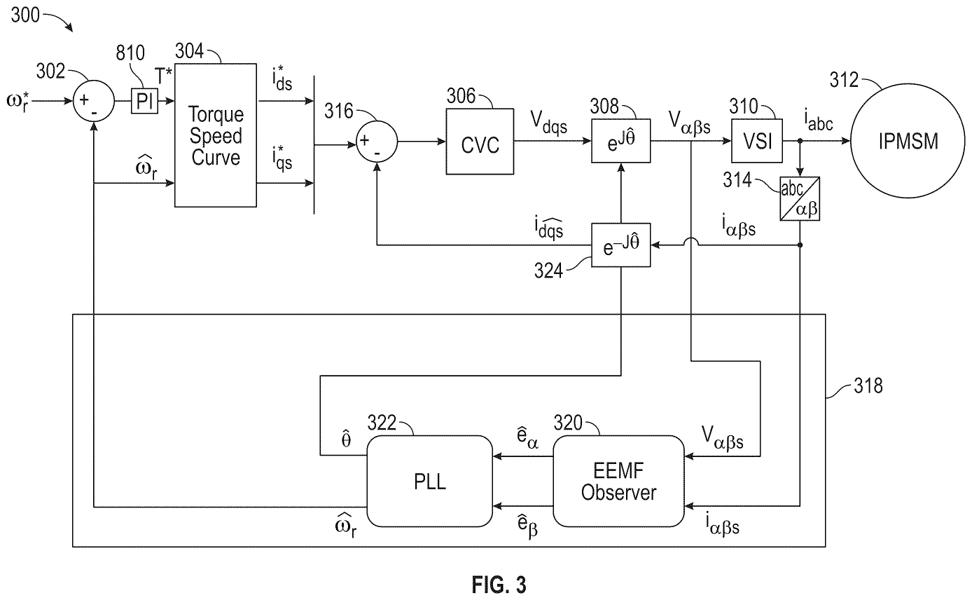

FIG. 3 is a block diagram of an example of a sensorless control system 300 for an Interior Permanent Magnet (IPM) motor. In a sensorless control system, rotor position and speed are estimated without a physical sensor. The techniques of this disclosure are applicable to all synchronous machines and not just IPM synchronous machines to both motoring and generation modes.

A difference between a reference rotor speed signal

$${ω}_{r}^{*}$$

and an estimated speed signal \hat{ω}ᵣ is determined at summing node 302 to generate a torque reference signal T*. This torque reference signal is processed using a torque-speed mapping 304, which generates current reference signals

$${i}_{ds}^{*} and {i}_{qs}^{*}$$

for the d- and q-axis components, respectively. These reference current signals are fed into a current vector controller 306 (CVC)ᵣ which compares them with the measured or estimated currents i_{ds} and i_{qs} to compute voltage command signal v_{dqs}.

An inverse Park transform 308 transforms the voltage command signal v_{dqs} to the stationary αβ reference frame using the estimated rotor electrical angle \hat{θ}ₑ, via the complex operator e^{j\hat{θ}}^{ₑ}. The resulting stationary-frame stator voltage vector v_{αβs} is applied to a voltage source inverter 310 (VSI), which converts it into three-phase voltages that drive the IPM machine 312. The voltage source inverter 310 outputs phase currents i_{abc}, which are measured and converted into the stationary αβ frame as a current measurement signal i_{αβs} using a Clarke transform 314. These current measurement signals are fed into a summing node 316 with the current reference signals

$${i}_{ds}^{*} and {i}_{qs}^{*}$$

and the result is fed to the current vector controller 306. In addition, the current measurement signal i_{αβs} is fed to the estimation subsystem 318.

The sensorless estimation subsystem 318 includes an extended electro-motive force observer (EEMF) 320 and a phase-locked loop 322 (PLL). The extended electromotive force observer 320 receives the measured stator voltage vector v_{αβs} and current i_{αβs}, and determines the estimated extended back-EMF component values ê_{α} and ê_{β}, which are components in the α-axis and the β-axis. These estimated back-EMF component values are input into the phase-locked loop 322, which determines the estimated angle \hat{θ} and the estimated angular speed \hat{ω}ᵣ from the estimated back-EMF component values. The estimated angular speed \hat{ω}ᵣ applied to the summing node 302 to close the speed loop and the estimated angle \hat{θ} is applied to the Park transform 324 to support the coordinate transformations.

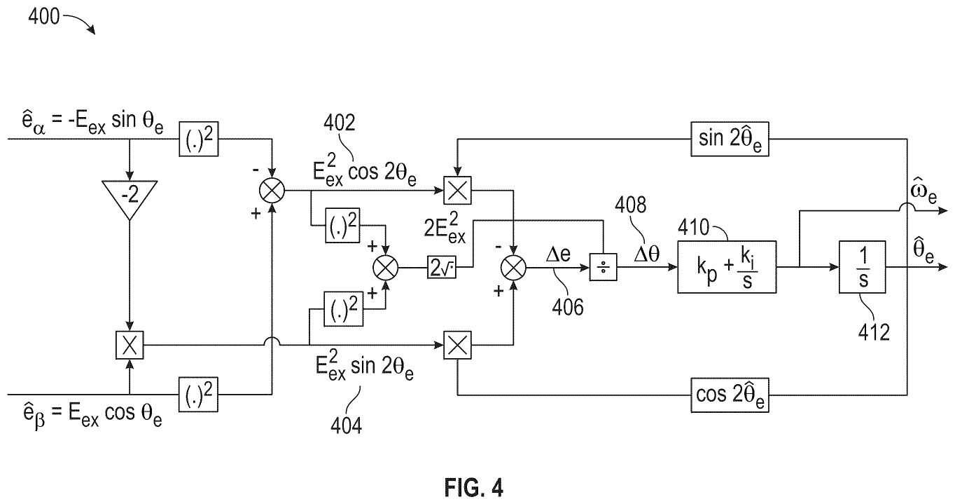

FIG. 4 is a block diagram of an example of an enhanced quadrature phase-locked loop 400 (EQPLL). In the enhanced quadrature phase-locked loop 400, the electrical signals ê_{α} and ê_{β} are indicative of machine operation and, more particularly, are extended EMF components. The extended EMF components ê_{α} and ê_{β} are determined by the extended electromotive force observer 320 of FIG. 3 and are determined using the voltage vector v_{αβs} and the phase currents i_{abc} of FIG. 3. The goal of the enhanced quadrature phase-locked loop 400 is to estimate the electrical angle \hat{θ}ₑ (or position) and rotor speed \hat{ω}ₑ from extended EMF components ê_{α} and ê_{β}. Eₑₓ is the magnitude of the EEMF and the closed-loop transfer function is:

$$\frac{{\hat{θ}}_{e}}{{θ}_{e}} = \frac{{k}_{p} s + {k}_{i}}{{s}^{2} + {k}_{p} s + {k}_{i}} ,$$

with constant pole locations. The PI controller gain parameters may be tuned as follows

$${k}_{p} = 2 {ζω}_{n} , {k}_{i} = {ω}_{n}^{2} ,$$

where ζ is the damping ratio and ωₙ is the natural frequency. As a rule-of-thumb, a value of ζ=0.6~0.8 gives good dynamic performance and the larger the ωₙ, the faster the dynamic response and the worse the filtering performance.

The EEMF component signals ê_{α} and ê_{β} are manipulated, such as by squaring and combining, to compute two quadrature signals

$${E}_{ex}^{2} sin 2 {θ}_{e}$$

at 402 and

$${E}_{ex}^{2} cos 2 {θ}_{e}$$

at 404, where the input signal ê_{α}=−Eₑₓ sin θₑ and the input signal ê_{β}=Eₑₓ cos θₑ. These terms are used to determine a primary error signal as follows:

$$Δ e = {E}_{ex}^{2} sin 2 {θ}_{e} cos 2 {\hat{θ}}_{e} - {E}_{ex} cos 2 {θ}_{e} sin 2 {\hat{θ}}_{e} = {E}_{ex}^{2} sin 2 ( {θ}_{e} - {\hat{θ}}_{e} ) \approx 2 {E}_{ex}^{2} ( {θ}_{e} - {\hat{θ}}_{e} ) ,$$

assuming small position error. A normalization is performed to obtain the final error signal as follows:

Δθ=θₑ−\hat{θ}ₑ,

which is input to the proportional-integral controller 410 with transfer function

$${k}_{p} + \frac{{k}_{i}}{s} .$$

The proportional-integral controller 410 generates an estimated angular speed signal \hat{ω}ₑ, which is integrated by integrator 412 to generate the estimated rotor electrical angle signal \hat{θ}ₑ (or position). The estimated angular speed signal \hat{ω}ₑ and the estimated rotor electrical angle signal \hat{θ}ₑ are output by the phase-locked loop 322 of FIG. 3.

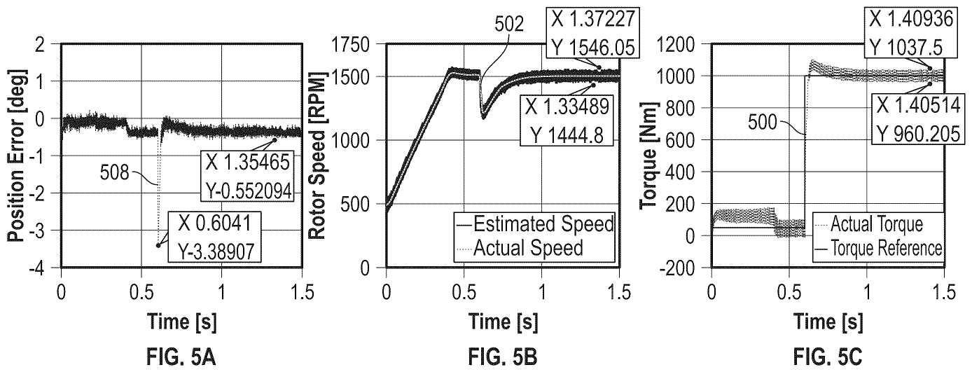

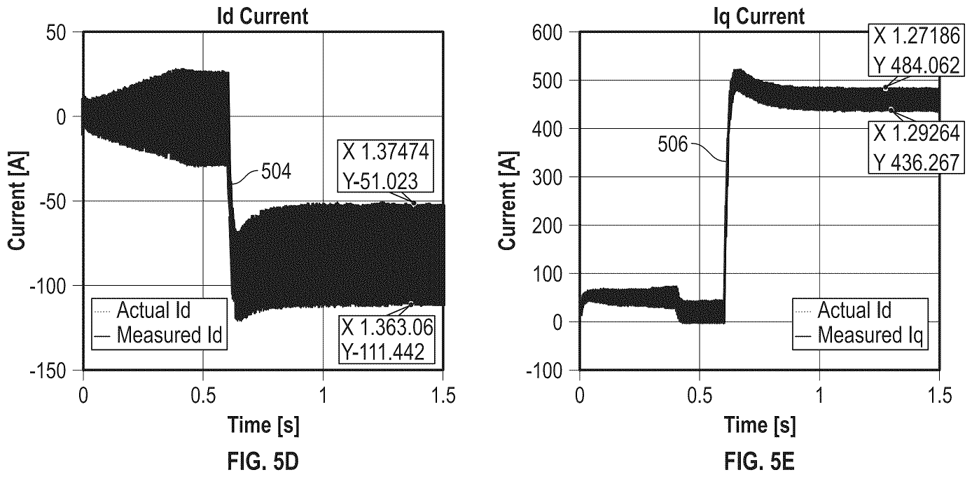

FIGS. 5A-5E depict various graphs showing simulation results depicting the open-loop performance of the enhanced quadrature phase-locked loop of FIG. 4. In the open-loop configuration, estimated speed and estimated position are not fed back to the main control.

FIG. 5A depicts the position error (y-axis) versus time (x-axis). FIG. 5B depicts the rotor speed (y-axis) versus time (x-axis). FIG. 5C depicts the torque (y-axis) versus time (x-axis). FIG. 5D depicts the Id current (y-axis) versus time (x-axis). FIG. 5E depicts the Iq current (y-axis) versus time (x-axis).

As seen in FIG. 5C, the torque is increased in a step-wise manner at 500 from about 75 newton-meters (Nm) to about 1000 Nm. As a result, the rotor speed dips, as seen at 502 in FIG. 5B. In addition, the Id current and the Iq current change drastically, as seen at 504 and 506, respectively, in FIG. 5D and FIG. 5E.

Because the EEMF component signals are indirectly related to the Id current and the Iq current, and the back-emf component signals are used to generate position error, as described above with respect to FIG. 4, the position error of FIG. 5A dips at 508 to about −3.4 degrees, indicating that the increase in torque has caused a position error. The techniques of this disclosure help reduce the dip at 508. Using simulation results, the inventors have found that the closed-loop performance of the enhanced quadrature phase-locked loop of FIG. 4 suffers from similar issues.

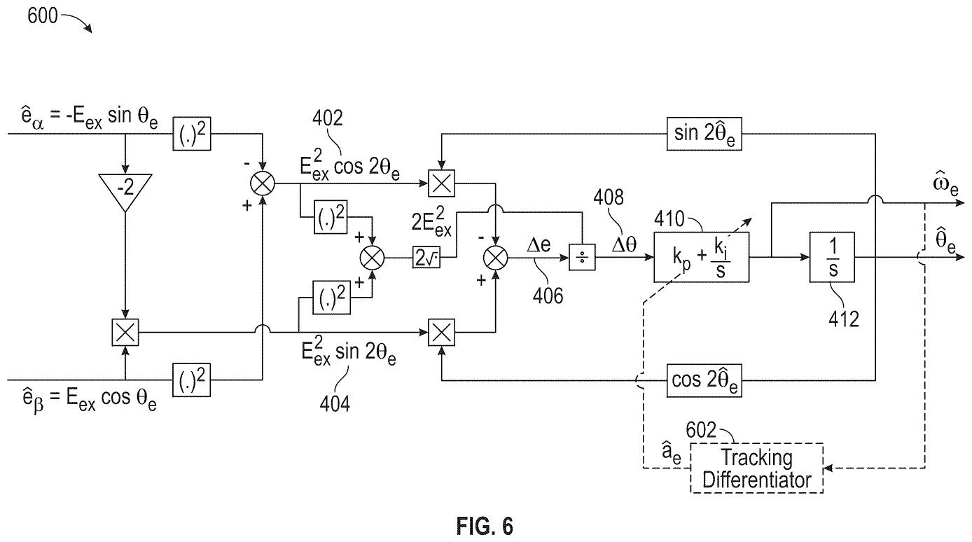

FIG. 6 is a block diagram of an example of a tracking differentiator-based variable phase-locked loop 600, in accordance with this disclosure. Some of the components of the variable phase-locked loop 600 are similar to the enhanced quadrature phase-locked loop 400 of FIG. 4 and use similar reference numbers or labels. For brevity, similar components will not be described in detail again.

The phase-locked loop 600 includes a tracking differentiator 602 where the dashed lines correspond to a variable gain scheduling structure. In the phase-locked loop 600, the gain parameters of the PLL, such as the phase-locked loop 322 of FIG. 3, are adapted as a function of estimated rotor acceleration. The estimation of rotor acceleration is performed using a tracking differentiator 602. The tracking differentiator 602, e.g., a high-performance tracking differentiator, receives the estimated angular rotor speed signal \hat{ω}ₑ as input and generates a smooth and clean estimated rotor acceleration signal âₑ as output. Then, the estimated acceleration signal is used to dynamically adjust the gain parameters kp and ki of the proportional-integral controller 410 so that the gain parameters become larger as acceleration magnitude increases during transient conditions while remaining as nominal values under steady state conditions. This dynamic adjustment improves the system's responsiveness and accuracy during transient conditions.

In some examples, the tracking differentiator 602 is implemented as a first-order tracking differentiator. The tracking differentiator 602 may be expressed as follows:

$${\dot{z}}_{0} = - {λ}_{0} {\vert {z}_{0} - y ( t ) \vert}^{\frac{1}{2}} sgn ( {z}_{0} - y ( t ) ) + {z}_{1} ,$$

$${\dot{z}}_{1} = - {λ}_{1} sgn ( {z}_{0} - y ( t ) ) ,$$

where

$${λ}_{0} = 1.5 {L}^{\frac{1}{2}} ,$$

λ₁=1.1L, L is Lipschitz constant parameter to tuned, y(t) is the input signal \hat{ω}ₑ (the estimated rotor speed signal) and z₁=âₑ is the differentiated signal output, i.e., estimated rotor acceleration. L is usually selected based on the maximum possible acceleration during operations. The function sgn( ) is the signum function. As such, the tracking differentiator 602 adapts the gain parameters (below) of the PLL using a sigmoid function.

Then, the estimated acceleration âₑ is used for scheduling the PI gain parameters using the following gain scheduling function:

$${k}_{p} = {k}_{p 0} + ( {k}_{p 1} - {k}_{p 0} ) [ \frac{2}{1 + {e}^{- {K}_{1} \vert {\hat{a}}_{e} \vert}} - 1 ] ,$$

$${k}_{i} = {k}_{i 0} + ( {k}_{i 1} - {k}_{i 0} ) [ \frac{2}{1 + {e}^{- {K}_{2} \vert {\hat{a}}_{e} \vert}} - 1 ] .$$

The scheduling law enforces the gain parameters to be the nominal values as kₚ=kₚ₀ and kᵢ=kᵢ₀ when there is no acceleration, âₑ=0. Therefore, the tuning of kₚ₀ and kᵢ₀ may follow the damping ratio and natural frequency parametrization. On the other hand, when the estimated acceleration goes to infinity, the gains will increase to kₚ=kₚ₁ and kᵢ=kᵢ₁. The gain parameter upper bounds kₚ₁, kᵢ₁ may be selected to help stabilize for possible intermediate gain parameter pairs.

The coefficients K₁ and K₂ denote the scheduling rate with respect to the acceleration input, which may be tuned according to dynamic performance. Some observations are that faster and larger scheduling of kₚ helps to reduce transient estimation error but also increases the oscillation in both speed and position estimation in transients. On the other hand, faster and larger scheduling of kᵢ helps reduce transient estimation slightly but may increase the oscillation and settling time toward steady state if transient kᵢ gain is too large.

The proportional-integral controller 410 generates an estimated angular speed signal \hat{ω}ₑ, which is integrated by integrator 412 to generate the estimated rotor electrical angle signal \hat{θ}ₑ (also referred to as the estimated angular position output signal \hat{θ}ₑ). The estimated angular speed signal \hat{ω}ₑ and the estimated rotor electrical angle signal \hat{θ}ₑ, are output by the phase-locked loop 322 of FIG. 3 as estimated angular speed signal \hat{ω}ᵣ and estimated rotor electrical angle signal \hat{θ}, \hat{θ} which is also referred to as the estimated angular position output signal. In this manner, the estimated angular position output is incorporated into the torque or speed control loop of the sensorless control system 300 to regulate the operation of the IPM machine 312.

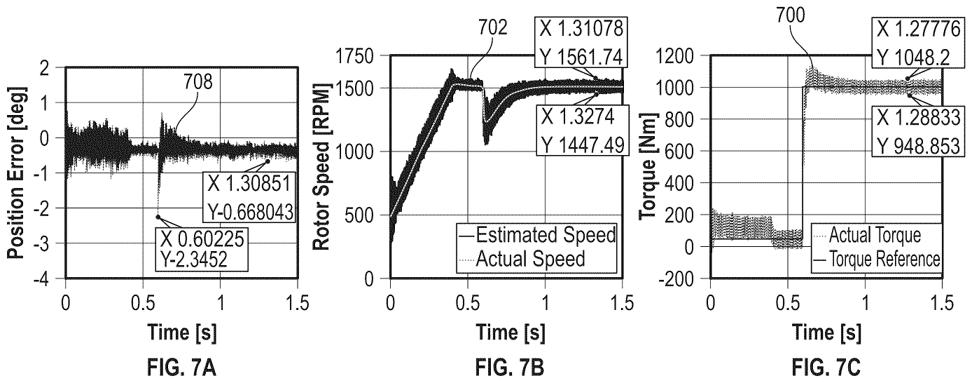

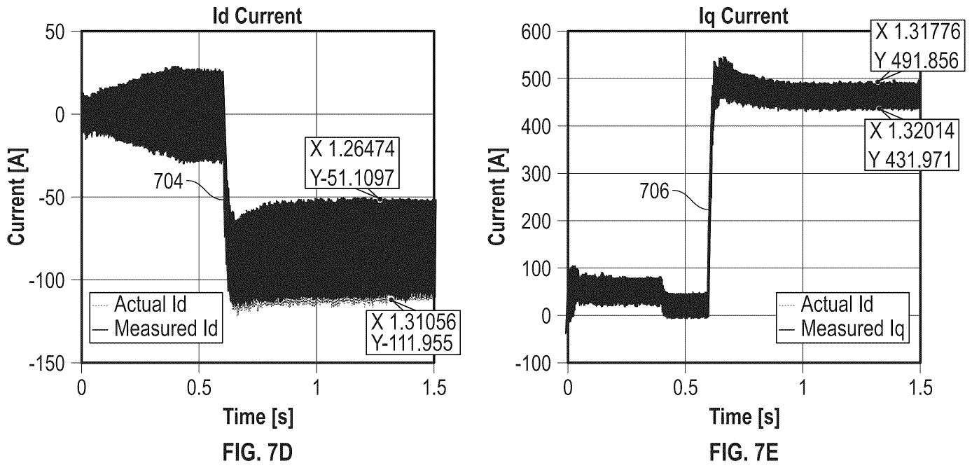

FIGS. 7A-7E depict various graphs showing simulation results depicting the closed-loop performance of the variable phase-locked loop 600 of FIG. 6. In the closed-loop configuration, the estimated speed and estimated position are fed back to the main control.

FIG. 7A depicts the position error (y-axis) versus time (x-axis). FIG. 7B depicts the rotor speed (y-axis) versus time (x-axis). FIG. 7C depicts the torque (y-axis) versus time (x-axis). FIG. 7D depicts the Id current (y-axis) versus time (x-axis). FIG. 7E depicts the Iq current (y-axis) versus time (x-axis).

As seen in FIG. 7C, the torque is increased in a step-wise manner at 700 from about 75 newton-meters (Nm) to about 1000 Nm. As a result, the rotor speed dips, as seen at 702 in FIG. 7B. In addition, the Id current and the Iq current change, as seen at 704 and 706, respectively, in FIG. 7D and FIG. 7E.

As seen in FIG. 7A, the position error dips at 708 to about −2.3 degrees, which is an improvement of about 1.1 degrees or about 32% over the enhanced quadrature phase-locked loop 400 of FIG. 4. More particularly, the variable phase-locked loop 600 techniques of FIG. 6 reduced the position error.

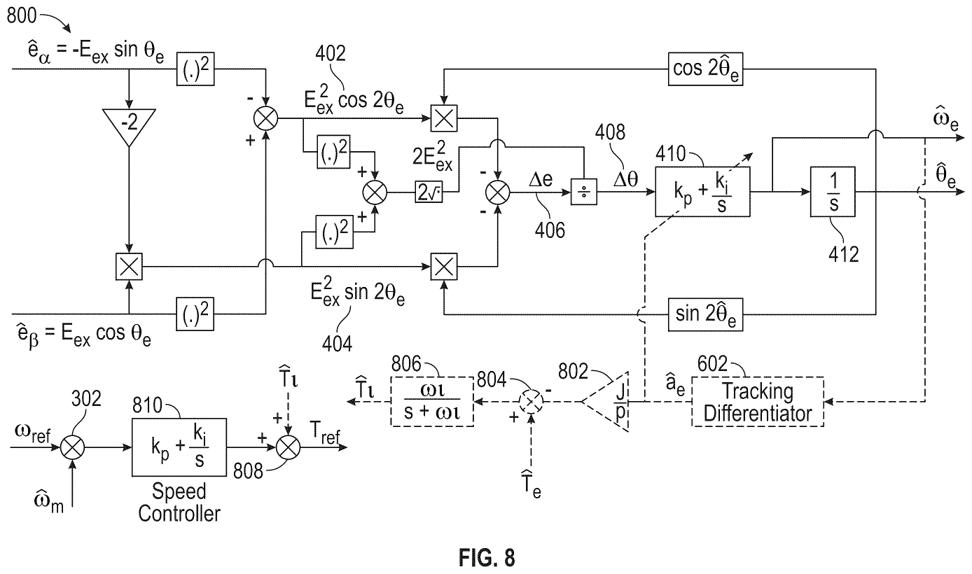

FIG. 8 is a block diagram of an example of a closed-loop tracking differentiator-based variable phase-locked loop 800 with speed compensation, in accordance with this disclosure. Some of the components of the variable phase-locked loop 800 are similar to the enhanced quadrature phase-locked loop 400 of FIG. 4 and the tracking differentiator-based variable phase-locked loop 600 and use similar reference numbers or labels. For brevity, similar components will not be described in detail again.

The phase-locked loop 800 is an example of a variable enhanced quadrature PLL with speed compensation. In the phase-locked loop 800, the estimated rotor acceleration signal âₑ from the tracking differentiator 602 of FIG. 6 is used to estimate a disturbance load torque \hat{T}ₗ, which is passed as a feed-forward signal to the speed control loop to improve the response.

More particularly, the estimated rotor acceleration signal âₑ from the tracking differentiator 602 is multiplied at block 802 by J/p to generate a scaled signal, where J is the rotor inertia, p is the number of pole-pairs in the electric machine, such as the IPM machine 312 of FIG. 3. The result is applied to a summing node 804 and subtracted from the estimated electromagnetic torque signal \hat{T}ₑ, which is generated from the electric machine, to generate a difference signal. The output of the summing node 804 is applied to a low-pass filter 806 having a transfer function of

$$\frac{{ω}_{l}}{{ω}_{l} + s} ,$$

where ωₗ is the cut-off frequency of the low-pass filter 806, which is used to maintain the causality and remove high-frequency noise.

The disturbance load torque is estimated from the estimated rotor acceleration as follows:

$${\hat{T}}_{l} = \frac{{ω}_{l}}{s + {ω}_{l}} ( {\hat{T}}_{e} - \frac{J}{p} {\hat{a}}_{e} ) ,$$

where \hat{T}ₑ is the estimated electromagnetic torque generated from the motor, J is the rotor inertia, p is the number of pole-pairs and ωₗ is the cut-off frequency of a low-pass filter being used to maintain the causality and remove high-frequency noise. This is derived from the rotor mechanical equation

J\dot{ω}ₘ=Tₑ−Tₗ,

assuming the friction coefficient is zero. The estimated disturbance load torque \hat{T}ₗ is then passed into the speed control loop as feedforward torque by addition. That is, the estimated disturbance load torque \hat{T}ₗ is applied to a summing node 808 along with an output of speed controller 810, such as a proportional-integral controller with gain parameters. The speed controller 810 is positioned between the summing node 302 and the torque-speed mapping 304 of FIG. 3. The output of the speed controller 810 is applied to the summing node 808 with the estimated disturbance load torque \hat{T}ₗ to generate the torque reference signal Tref, which is the torque reference signal T* of FIG. 3. It should be noted that the estimated angular speed \hat{ω}ₘ is the estimated angular speed \hat{ω}ᵣ of FIG. 3 and the reference rotor speed signal ω_{ref} is the reference rotor speed signal ω*ᵣ of FIG. 3.

Improving the speed control performance by load disturbance compensation may also benefit the position estimation in the sense that the acceleration/deacceleration transient phase induced by unforeseen disturbance load may be minimized. Therefore, the variable PLL with speed compensation may enhance the robustness against disturbance and the overall dynamic performance for both speed control and sensorless estimation.

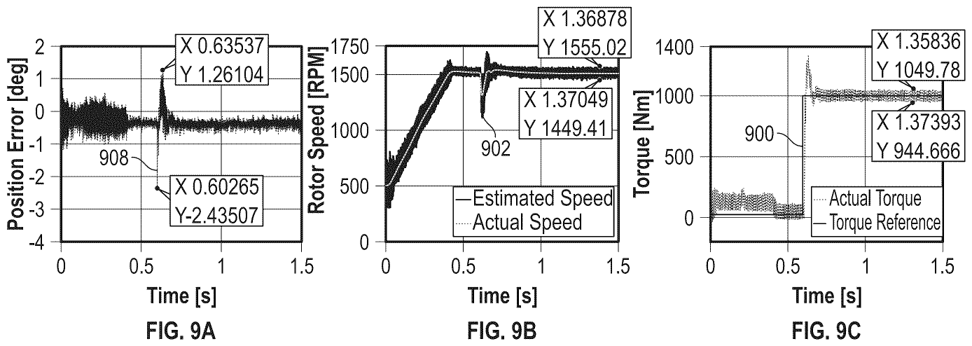

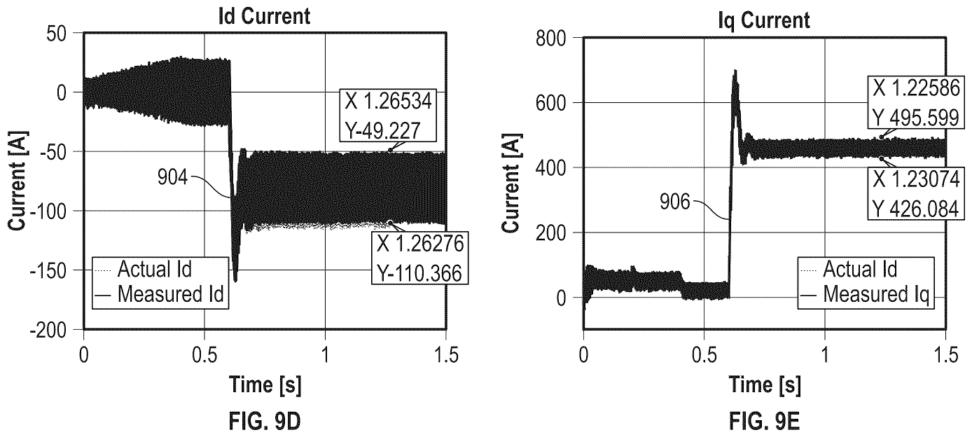

FIGS. 9A-9E depict various graphs showing simulation results depicting the closed-loop performance of the tracking differentiator-based variable phase-locked loop 800 with speed compensation of FIG. 8. In the closed-loop configuration, the estimated speed and estimated position are fed back to the main control.

FIG. 9A depicts the position error (y-axis) versus time (x-axis). FIG. 9B depicts the rotor speed (y-axis) versus time (x-axis). FIG. 9C depicts the torque (y-axis) versus time (x-axis). FIG. 9D depicts the Id current (y-axis) versus time (x-axis). FIG. 9E depicts the Iq current (y-axis) versus time (x-axis).

As seen in FIG. 9C, the torque is increased in a step-wise manner at 900 from about 75 newton-meters (Nm) to about 1000 Nm. As a result, the rotor speed dips, as seen at 902 in FIG. 9B. In addition, the Id current and the Iq current change, as seen at 904 and 906, respectively, in FIG. 9D and FIG. 9E.

As seen in FIG. 9A, the position error dips at 908 to about −2.4 degrees, which is about the same as the tracking differentiator-based variable phase-locked loop 600 of FIG. 6. However, using the speed compensation techniques of FIG. 8, the rotor speed recovers more quickly than the tracking differentiator-based variable phase-locked loop 600 of FIG. 6 or the enhanced quadrature phase-locked loop 400 of FIG. 4. That is, less time is needed for the rotor speed to rebound from the dip 902 to a speed of about 1500 RPM than in the enhanced quadrature phase-locked loop 400 of FIG. 4.

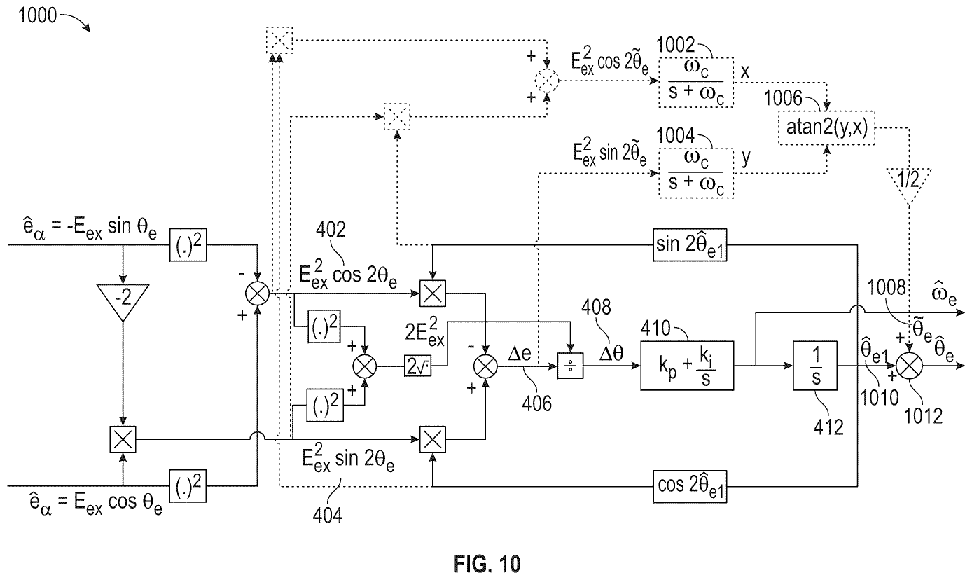

FIG. 10 is a block diagram of an example of a feedforward phase-locked loop 1000, in accordance with this disclosure. Some of the components of the feedforward phase-locked loop 1000 are similar to those of the enhanced quadrature phase-locked loop 400 of FIG. 4 and use similar reference numbers or labels. For brevity, similar components will not be described in detail again.

In the feedforward phase-locked loop 1000, a rotor angle feedforward signal \tilde{θ}ₑ is generated and the angular position output signal \hat{θ}ₑ of the rotor is adjusted using the rotor angle feedforward signal \tilde{θ}ₑ.

$${E}_{ex}^{2} cos 2 {\tilde{θ}}_{e}$$

is computed by manipulating the terms. The obtained

$${E}_{ex}^{2} cos 2 {\tilde{θ}}_{e} and {E}_{ex}^{2} sin 2 {\tilde{θ}}_{e}$$

terms are applied to first-order low-pass filters 1002, 1004, respectively, with cut-off frequency ω_{c} to remove high-frequency noise. Then a tan 2 block 1006 is used to compute the feedforward estimated signal \tilde{θ}ₑ 1008 as feedforward to the angular position output signal \hat{θ}ₑ of the rotor. As seen in FIG. 10, the integrator 412 generates the first estimated signal \tilde{θ}ₑ₁ 1010, which is applied to a summing node 1012 with the error signal \tilde{θ}ₑ 1008 to generate the angular position output signal \hat{θ}ₑ of the rotor.

The cut-off frequency ω_{c} determines the feedforward dynamic response. Larger ω_{c} leads to faster dynamic response but also more signal noise. This is shown by examining the equivalent closed-loop transfer function as

$$\frac{{\hat{θ}}_{e}}{{θ}_{e}} = \frac{{k}_{p} s + {k}_{i}}{{s}^{2} + {k}_{p} s + {k}_{i}} + \frac{{s}^{2}}{{s}^{2} + {k}_{p} s + {k}_{i}^{2}} \frac{{ω}_{c}}{s + {ω}_{c}} = \frac{( {k}_{p} + {ω}_{c} ) {s}^{2} + ( {k}_{p} {ω}_{c} + {k}_{i} ) s + {ω}_{c} {k}_{i}}{( {s}^{2} + {k}_{p} s + {k}_{i} ) ( s + {ω}_{c} )} .$$

The pole of the feedforward phase-locked loop closed-loop transfer function is the union of the original EQPLL and additional low-pass filters. It may be desirable to select the cut-off frequency ω_{c} according to the estimated EEMF signal quality.

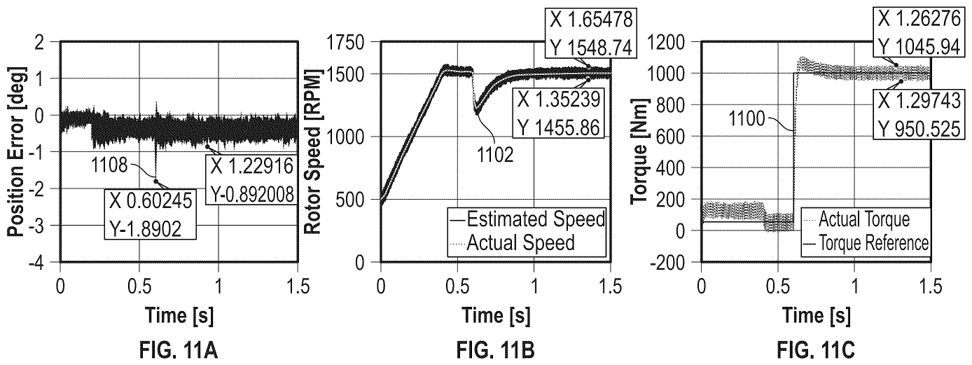

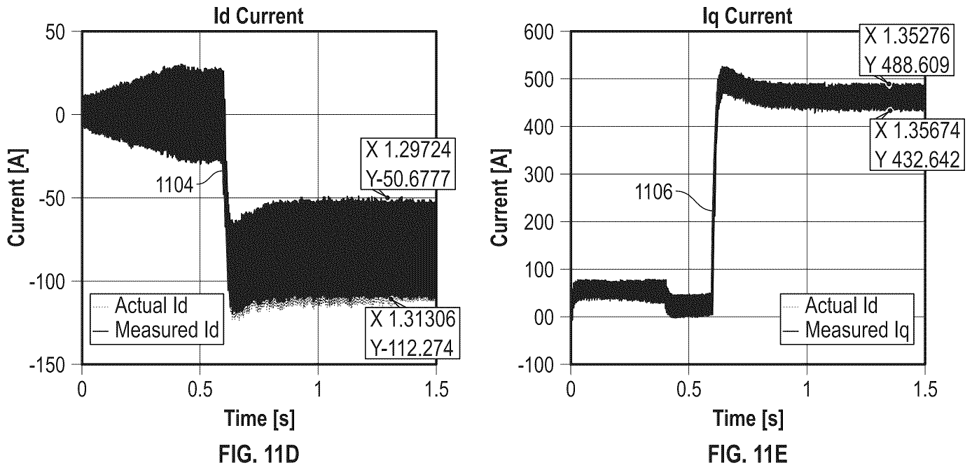

FIGS. 11A-11E depict various graphs showing simulation results depicting the closed-loop performance of the feedforward phase-locked loop 1000 of FIG. 10. In the closed-loop configuration, the estimated speed and estimated position are fed back to the main control.

FIG. 11A depicts the position error (y-axis) versus time (x-axis). FIG. 11B depicts the rotor speed (y-axis) versus time (x-axis). FIG. 11C depicts the torque (y-axis) versus time (x-axis). FIG. 11D depicts the Id current (y-axis) versus time (x-axis). FIG. 11E depicts the Iq current (y-axis) versus time (x-axis).

As seen in FIG. 11C, the torque is increased in a step-wise manner at 1100 from about 75 newton-meters (Nm) to about 1000 Nm. As a result, the rotor speed dips, as seen at 1102 in FIG. 9B. In addition, the Id current and the Iq current change, as seen at 1104 and 1106, respectively, in FIG. 11D and FIG. 11.

As seen in FIG. 11A, the position error dips at 1108 to about −1.9 degrees, which is an improvement of about 1.5 degrees or about 44% over the enhanced quadrature phase-locked loop 400 of FIG. 4 and is even better than the performance of the variable phase-locked loop 600 techniques of FIG. 6 and the closed-loop tracking differentiator-based variable phase-locked loop 800 with speed compensation of FIG. 8.

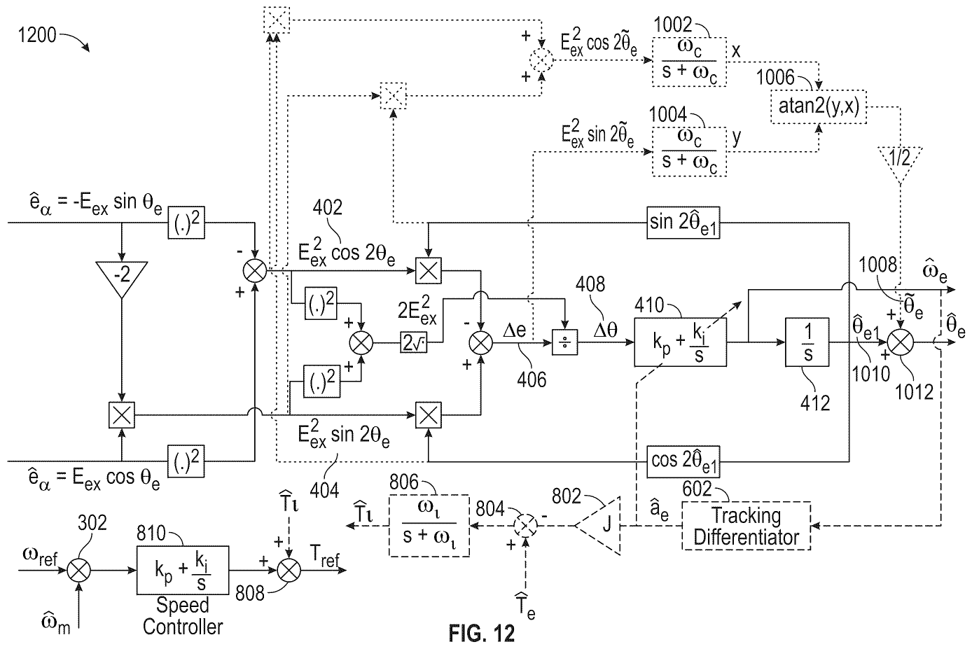

FIG. 12 is a block diagram of an example of a phase-locked loop 1200 that includes the closed-loop tracking differentiator-based variable phase-locked loop 800 with speed compensation of FIG. 8 and the feedforward phase-locked loop 1000 of FIG. 10, in accordance with this disclosure. Some of the components of the phase-locked loop 1200 are similar to those of the closed-loop tracking differentiator-based variable phase-locked loop 800 with speed compensation of FIG. 8 and the feedforward phase-locked loop 1000 of FIG. 10 and use similar reference numbers or labels. For brevity, similar components will not be described in detail again.

In the phase-locked loop 1200, by using the speed compensation techniques of FIG. 8, the rotor speed recovers much more quickly than the tracking differentiator-based variable phase-locked loop 600 of FIG. 6 or the enhanced quadrature phase-locked loop 400 of FIG. 4. And, by also using the feedforward techniques of FIG. 10, the position error is even better than the performance of the variable phase-locked loop 600 techniques of FIG. 6 and the closed-loop tracking differentiator-based variable phase-locked loop 800 with speed compensation of FIG. 8.

### INDUSTRIAL APPLICABILITY

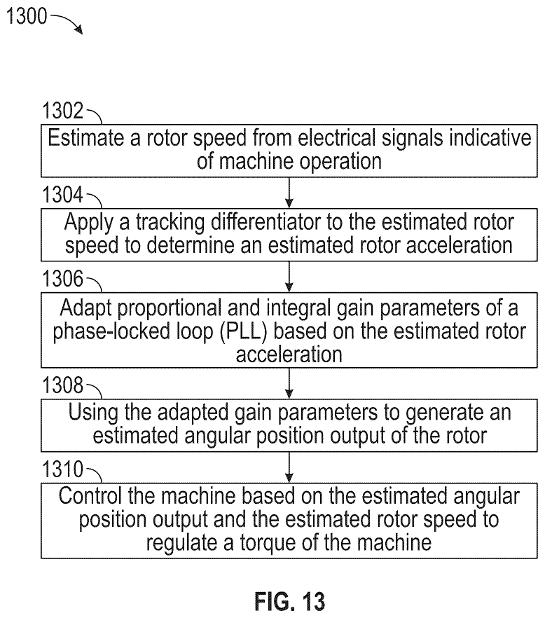

FIG. 13 is a flow diagram of an example of a method 1300 for improving an accuracy of rotor position estimation of a rotor in a permanent magnet synchronous machine, in accordance with this disclosure. At block 1302, the method 1300 includes estimating a rotor speed from electrical signals indicative of machine operation. For example, the tracking differentiator-based variable phase-locked loop 600 of FIG. 6 estimates the electrical angle \hat{θ}ₑ (or position) and rotor speed \hat{ω}ₑ from extended EMF components ê_{α} and ê_{β}, which are indicative of the operation of the electric machine, such as the interior permanent magnet machine 202 of FIG. 2.

At block 1304, the method 1300 includes applying a tracking differentiator to the estimated rotor speed to determine an estimated rotor acceleration. For example, the tracking differentiator-based variable phase-locked loop 600 of FIG. 6 applies the tracking differentiator 602 to the estimated rotor speed \hat{ω}ₑ to determine an estimated rotor acceleration âₑ.

At block 1306, the method 1300 includes adapting proportional and integral gain parameters of a phase-locked loop (PLL) based on the estimated rotor acceleration. For example, the tracking differentiator-based variable phase-locked loop 600 of FIG. 6 adapts the gain parameters kp and ki of the proportional-integral controller 410 based on the estimated rotor acceleration âₑ.

At block 1308, the method 1300 includes using the adapted gain parameters to generate an estimated angular position output of the rotor. For example, the proportional-integral controller 410 of FIG. 6 uses the gain parameters kp and ki to generate an estimated angular speed signal \hat{ω}ₑ, which is integrated by integrator 412 to generate the estimated rotor electrical angle signal \hat{θ}ₑ (or position).

At block 1310, the method 1300 includes controlling the machine based on the estimated angular position output and the estimated rotor speed to regulate a torque of the machine. For example, the estimated electrical angle \hat{θ}ₑ (or position) and rotor speed \hat{ω}ₑ of FIG. 6 are applied to the summing node 302 of FIG. 3 and, using the torque-speed mapping 304, the sensorless control system 300 controls the IPM machine 312 by regulating its torque.

In some examples, controlling the machine based on the estimated angular position output includes: incorporating the estimated angular position output into a torque control loop to regulate the machine operation.

In some examples, adapting the gain parameters of the PLL based on the estimated rotor acceleration includes using a gain scheduling function. In some examples, adapting the gain parameters of the PLL based on the estimated rotor acceleration includes adjusting the gain parameters using a sigmoid function.

In some examples, the tracking differentiator is implemented as a first-order differentiator.

In some examples, the method 1300 includes estimating a load torque from the estimated rotor acceleration; and applying the estimated load torque as a feedforward term in a speed control loop.

In some examples, estimating the load torque from the estimated rotor acceleration includes: multiplying the estimated rotor acceleration by J/p to generate a scaled signal, where J is a rotor inertia and p is a number of pole-pairs in the machine; subtracting the scaled signal from an estimated electromagnetic torque signal to generate a difference signal; and filtering the difference signal to generate an estimated load torque signal.

In some examples, the method 1300 includes generating a rotor angle feedforward term; and adjusting, using the rotor angle feedforward term, the estimated angular position output of the rotor.

In some examples, the method 1300 includes using an extended electromotive force observer to determine the electrical signals indicative of machine operation, wherein the electrical signals indicative of machine operation include estimated back electromotive force signals.

The techniques described above for improving rotor position and speed estimation in permanent magnet machines are highly applicable to electrified machines, including load-haul-dump (LHD) vehicles and other large industrial electrified equipment. These techniques enable precise motor control for smooth acceleration, deceleration, and torque regulation, ensuring reliable operation under varying load conditions.

In LHD vehicles, the techniques enhance performance during heavy material transport by accurately compensating for dynamic load torque and maintaining stable speed control. For other large electrified machines, such as mining equipment and construction machinery, the techniques improve energy efficiency and operational robustness, even in harsh environments with fluctuating loads. By addressing the challenges of traditional sensorless control systems, these advancements provide reliable and efficient motor control solutions for demanding industrial applications.

What is claimed is:

1. A method for improving an accuracy of rotor position estimation of a rotor in a permanent magnet machine, the method comprising:
estimating a rotor speed from electrical signals indicative of machine operation;
applying a tracking differentiator to the estimated rotor speed to determine an estimated rotor acceleration;
adapting proportional and integral gain parameters of a phase-locked loop (PLL) based on the estimated rotor acceleration;
using the adapted gain parameters to generate an estimated angular position output of the rotor; and
controlling the machine based on the estimated angular position output and the estimated rotor speed to regulate a torque of the machine.

2. The method of claim 1, wherein controlling the machine based on the estimated angular position output includes:
incorporating the estimated angular position output into a torque or speed control loop to regulate the machine operation.

3. The method of claim 1, wherein adapting the gain parameters of the PLL based on the estimated rotor acceleration includes using a gain scheduling function.

4. The method of claim 1, wherein adapting the gain parameters of the PLL based on the estimated rotor acceleration includes adjusting the gain parameters using a sigmoid function.

5. The method of claim 1, wherein the tracking differentiator is implemented as a first-order differentiator.

6. The method of claim 1, further comprising:
estimating a load torque from the estimated rotor acceleration; and
applying the estimated load torque as a feedforward term in a speed control loop.

7. The method of claim 6, wherein estimating the load torque from the estimated rotor acceleration includes:
multiplying the estimated rotor acceleration by J/p to generate a scaled signal, where J is a rotor inertia and p is a number of pole-pairs in the machine;
subtracting the scaled signal from an estimated electromagnetic torque signal to generate a difference signal; and
filtering the difference signal to generate an estimated load torque signal.

8. The method of claim 1, further comprising:
generating a rotor angle feedforward term; and
adjusting, using the rotor angle feedforward term, the estimated angular position output of the rotor.

9. The method of claim 1, further comprising:
using an extended electromotive force observer to determine the electrical signals indicative of machine operation, wherein the electrical signals indicative of machine operation include estimated back electromotive force signals.

10. A motor system comprising:
a permanent magnet motor including a rotor:
a motor controller configured for:
receiving an estimated rotor speed signal derived from electrical signals indicative of motor operation;
applying the estimated rotor speed to determine an estimated rotor acceleration;
adapting proportional and integral gain parameters of a phase-locked loop (PLL) based on the estimated rotor acceleration;
using the adapted gain parameters to generate an estimated angular position output of the rotor; and
controlling the motor based on the estimated angular position output and the estimated rotor speed to regulate a torque of the motor.

11. The motor system of claim 10, wherein controlling the motor based on the estimated angular position output includes:
incorporating the estimated angular position output into a torque control loop to regulate the motor operation.

12. The motor system of claim 10, wherein adapting the gain parameters of the PLL based on the estimated rotor acceleration includes using a gain scheduling function.

13. The motor system of claim 10, wherein the controller is further configured for:
estimating a load torque from the estimated rotor acceleration; and
applying the estimated load torque as a feedforward term in a speed control loop.

14. The motor system of claim 13, wherein estimating the load torque from the estimated rotor acceleration includes:
multiplying the estimated rotor acceleration by J/p to generate a scaled signal, where J is a rotor inertia and p is a number of pole-pairs in the motor;
subtracting the scaled signal from an estimated electromagnetic torque signal to generate a difference signal; and
filtering the difference signal to generate an estimated load torque signal.

15. The motor system of claim 10, wherein the controller is further configured for:
generating a rotor angle feedforward term; and
adjusting, using the rotor angle feedforward term, the estimated angular position output of the rotor.

16. A motor controller for improving an accuracy of a rotor position estimation in an interior permanent magnet motor, the motor controller comprising:
a tracking differentiator configured for:
receiving an estimated rotor speed signal derived from electrical signals indicative of motor operation and calculate an estimated rotor acceleration signal by determining a first derivative of the estimated rotor speed; and
adapting proportional and integral gains of a phase-locked loop (PLL) based on the estimated rotor acceleration signal using a gain scheduling function;
a phase-locked loop configured for using the adapted proportional and integral gains to generate an angular position output of a rotor; and
a torque control loop configured to incorporate the angular position output to regulate motor operation.

17. The motor controller of claim 16, wherein controlling the motor based on the estimated angular position output includes:
incorporating the estimated angular position output into a torque control loop to regulate the motor operation.

18. The motor controller of claim 16, wherein the motor controller further comprises:
a load torque estimator configured for:
estimating a load torque from the estimated rotor acceleration,
wherein the phase-locked loop is further configured for applying the estimated load torque as a feedforward term in a torque control loop.

19. The motor controller of claim 18, wherein the load torque estimator is further configured for:
multiplying the estimated rotor acceleration by J/p to generate a scaled signal, where J is a rotor inertia and p is a number of pole-pairs in the motor;
subtracting the scaled signal from an estimated electromagnetic torque signal to generate a difference signal; and
filtering the difference signal to generate an estimated load torque signal.

20. The motor controller of claim 16, further comprising:
rotor angle feedforward circuitry configured for generating a rotor angle feedforward term,
wherein the phase-locked loop is further configured for adjusting, using the rotor angle feedforward term, the estimated angular position output of the rotor.
